(19) United States
(12) Patent Application Publication
(10) Pub. No.: US 2024/0237180 A9
(43) Pub. Date: Jul. 11, 2024

(54) WAVEFORM FOR LOW VOLTAGE CONDUCTED ELECTRICAL WEAPON

(71) Applicant: Axon Enterprise, Inc., Scottsdale, AZ (US)

(72) Inventors: Magne H. Nerheim, Paradise Valley, AZ (US); Varun Sathyanarayan, Phoenix, AZ (US); Ryan C. Markle, Peoria, AZ (US)

(21) Appl. No.: 18/362,929

(22) Filed: Jul. 31, 2023

Related U.S. Application Data
(60) Provisional application No. 63/369,949, filed on Jul. 30, 2022.

(51) Int. Cl. H05C 1/06; H05C 3/00

(52) U.S. Cl. CPC H05C 1/06; H05C 3/00

(57) ABSTRACT

A duration of a stimulus signal delivered to a target by a conducted electrical weapon may be selected in accordance with a current of the stimulus signal delivered to the target. The current may be measured by the conducted electrical weapon. The current may comprise a measured current of a pulse of the stimulus signal. The duration may be selected while the pulse is delivered to the target. The duration may be selected from a range of durations for which the stimulus signal may be applied. The range of durations may comprise a range of increasing pulse durations associated with a range of increasing charges provided by the stimulus signal in accordance with combinations of respective measured currents of a range of measured currents and respective pulse durations of the increasing pulse durations. A charge delivered by a measured current and a selected duration may increase as the measured current decreases.

### FIELD OF THE INVENTION

Embodiments of the present disclosure relate to a conducted electrical weapon (“CEW”). Specifically, the conducted electrical weapon may employ a stimulus signal using a low voltage source.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a schematic diagram of a conducted electrical weapon, in accordance with various embodiments;

FIG. 2 illustrates a schematic diagram of a conducted electrical weapon comprising deployed electrodes according to various aspects of the disclosure;

FIG. 3 illustrates a method of generating a pulse of a stimulus signal in accordance with various aspects of the disclosure; and

FIG. 4 illustrates pulse durations selectable for generating a pulse of a stimulus signal according to various aspects of the disclosure.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Additionally, any reference to without contact (or similar phrases) may also include reduced contact or minimal contact. Surface shading lines may be used throughout the figures to denote different parts but not necessarily to denote the same or different materials.

Systems, methods, and apparatuses may be used to interfere with voluntary locomotion (e.g., walking, running, moving, etc.) of a target. For example, a conducted electrical weapon may be used to deliver (e.g., conduct) a stimulus signal through tissue of a human or animal target. The stimulus signal may comprise an electrical signal output from the conducted electrical weapon. The stimulus signal may be distinct from a power supply signal, a control signal, or other internal electrical signals used internally by a conducted electrical weapon to generate the stimulus signal delivered to a target. The stimulus signal may comprise a series of pulses (e.g., pulses of a stimulus signal). The stimulus signal may comprise a voltage at which the stimulus signal is delivered to the target. The stimulus signal may be delivered over a period of time. The stimulus signal may comprise a current. The current may be determined in accordance with a voltage of the stimulus signal and an impedance (e.g., load impedance) of target to which the voltage is coupled to deliver the stimulus signal. The stimulus signal may comprise a charge determined in accordance with delivery of a current over a period of time. Although referred to as a conducted electrical weapon, in the present disclosure, a conducted electrical weapon (“CEW”) may refer to an electrical weapon, a conductive electrical weapon, an energy weapon, a conducted energy weapon, and/or any other similar device or apparatus configured to provide a stimulus signal through one or more deployed projectiles (e.g., electrodes).

A stimulus signal carries an electrical charge into target tissue. The stimulus signal may interfere with voluntary locomotion of the target. The stimulus signal may cause pain. The pain may also function to encourage the target to stop moving. The stimulus signal may cause skeletal muscles of the target to become stiff (e.g., lock up, freeze, etc.). The stiffening of the muscles in response to a stimulus signal may be referred to as neuromuscular incapacitation (“NMI”). NMI disrupts voluntary control of the muscles of the target. A pulse of a stimulus signal may excite a muscle such that voluntary control of the muscle is prevented. The inability of the target to control its muscles interferes with locomotion of the target.

A stimulus signal may be delivered through the target via terminals coupled to the CEW. Delivery via terminals may be referred to as a local delivery (e.g., a local stun, a drive stun, etc.). During local delivery, the terminals are brought close to the target by positioning the CEW proximate to the target. The stimulus signal is delivered through the target's tissue via the terminals. To provide local delivery, the CEW is generally disposed within arm's reach of the target and the terminals of the CEW are brought into contact with or proximate to the target.

A stimulus signal may be delivered through the target via two or more wire-tethered electrodes. Delivery via wire-tethered electrodes may be referred to as a remote delivery (e.g., a remote stun). During a remote delivery, the CEW may be separated from the target up to the length (e.g., 15 feet, 20 feet, 30 feet, etc.) of the wire tether. The CEW launches the electrodes towards the target. As the electrodes travel toward the target, the respective wire tethers deploy behind the electrodes. The wire tether electrically couples the CEW to the electrode. The electrode may electrically couple to the target thereby coupling the CEW to the target. In response to the electrodes connecting with, impacting on, or being positioned proximate to the target's tissue, the current may be provided through the target via the electrodes (e.g., a circuit is formed through the first tether and the first electrode, the target's tissue, and the second electrode and the second tether).

Terminals or electrodes that contact or are proximate to the target's tissue deliver the stimulus signal through the target. Contact of a terminal or electrode with the target's tissue establishes an electrical coupling with the target's tissue. Electrodes may include a spear that may pierce the target's tissue to contact the target. A terminal or electrode that is proximate to the target's tissue may use ionization to establish an electrical coupling with the target's tissue. Ionization may also be referred to as arcing.

In use (e.g., during deployment), a terminal or electrode may be separated from the target's tissue by the target's clothing or a gap of air. In various embodiments, a signal generator of the CEW may provide the stimulus signal (e.g., current, pulses of current, etc.) at a high voltage (e.g., in the range of 40,000 to 100,000 volts) to ionize the air in the clothing or the air in the gap that separates the terminal or electrode from the target's tissue. Ionizing the air establishes a low impedance ionization path from the terminal or electrode to the target's tissue that may be used to deliver the stimulus signal into the target's tissue via the ionization path. The ionization path persists (e.g., remains in existence, lasts, etc.) as long as the current of a pulse of the stimulus signal is provided via the ionization path. When the current ceases or is reduced below a threshold (e.g., amperage, voltage), the ionization path collapses (e.g., ceases to exist) and the terminal or electrode is no longer electrically coupled to the target's tissue. Lacking the ionization path, the impedance between the terminal or electrode and target tissue is high. A high voltage in the range of about 50,000 volts can ionize air in a gap of up to about one inch.

A CEW may provide a stimulus signal as a series of current pulses. Each current pulse may include a high voltage portion (e.g., 40,000-100,000 volts) and a low voltage portion (e.g., 500-6,000 volts). The high voltage portion of a pulse of a stimulus signal may ionize air in a gap between an electrode or terminal and a target to electrically couple the electrode or terminal to the target. In response to the electrode or terminal being electrically coupled to the target, the low voltage portion of the pulse delivers an amount of charge into the target's tissue via the ionization path. In response to the electrode or terminal being electrically coupled to the target by contact (e.g., touching, spear embedded into tissue, etc.), the high portion of the pulse and the low portion of the pulse both deliver charge to the target's tissue. Generally, the low voltage portion of the pulse delivers a majority of the charge of the pulse into the target's tissue. In various embodiments, the high voltage portion of a pulse of the stimulus signal may be referred to as the spark or ionization portion. The low voltage portion of a pulse may be referred to as the muscle portion.

In various embodiments, a signal generator of the CEW may provide the stimulus signal (e.g., current, pulses of current, etc.) at only a low voltage (e.g., less than 2,500 volts). The low voltage may comprise a lower voltage than a high voltage (having at least a portion in the range of 40,000 to 100,000 volts). A maximum voltage of a low voltage CEW may be less than 5,000 volts or, in other embodiments, less than 2,500 volts. A stimulus signal provided at the low voltage may not ionize the air in the clothing or the air in the gap that separates the terminal or electrode from the target's tissue. A CEW having a signal generator providing stimulus signals at only a low voltage (e.g., a low voltage signal generator, low voltage signal source) may require deployed electrodes to be electrically coupled to the target by contact (e.g., touching, spear embedded into tissue, etc.).

A CEW may include at least two terminals at the face of the CEW. A CEW may include two terminals for each bay that accepts a deployment unit (e.g., cartridge). The terminals are spaced apart from each other. In response to the electrodes of the deployment unit in the bay having not been deployed, the high voltage impressed across the terminals will result in ionization of the air between the terminals. The arc between the terminals may be visible to the naked eye. In response to a launched electrode not electrically coupling to a target, the current that would have been provided via the electrodes may arc across the face of the CEW via the terminals.

The likelihood that the stimulus signal will cause NMI increases when the electrodes that deliver the stimulus signal are spaced apart at least 6 inches (15.24 centimeters) so that the current from the stimulus signal flows through the at least 6 inches of the target's tissue. In various embodiments, the electrodes preferably should be spaced apart at least 12 inches (30.48 centimeters) on the target. Because the terminals on a CEW are typically less than 6 inches apart, a stimulus signal delivered through the target's tissue via terminals likely will not cause NMI, only pain.

A series of pulses may include two or more pulses separated in time. Each pulse delivers an amount of charge into the target's tissue. In response to the electrodes being appropriately spaced (as discussed above), the likelihood of inducing NMI increases as each pulse delivers an amount of charge in the range of 55 microcoulombs to 85 microcoulombs per pulse. In embodiments, the likelihood of inducing NMI increases when the rate of pulse delivery (e.g., rate, pulse rate, repetition rate, etc.) is between 11 pulses per second (“pps”) and 50 pps. Pulses delivered at a higher rate may provide less charge per pulse to induce NMI. Pulses that deliver more charge per pulse may be delivered at a lesser rate to induce NMI. In various embodiments, a CEW may be hand-held and use batteries to provide the pulses of the stimulus signal. In response to the amount of charge per pulse being high and the pulse rate being high, the CEW may use more energy than is needed to induce NMI. Using more energy than is needed depletes batteries more quickly.

In various embodiments, a CEW may include a handle and two or more deployment units. The handle may include one or more bays for receiving the deployment units. Each deployment unit may be removably positioned in (e.g., inserted into, coupled to, etc.) a bay. Each deployment unit may releasably electrically, electronically, and/or mechanically couple to a bay. A deployment of the CEW may launch one or more electrodes toward a target to remotely deliver the stimulus signal through the target.

In various embodiments, a deployment unit may include a single electrode. The deployment unit may deploy (e.g., launch) the single electrode individually. Launching the electrode may be referred to as activating (e.g., firing) a deployment unit. After use (e.g., activation, firing), a deployment unit may be removed from the bay and replaced with an unused (e.g., not fired, not activated) deployment unit to permit launch of additional electrodes.

Embodiments according to various aspects of the present disclosure comprise systems, methods, and devices for generating a waveform for a conducted electrical weapon. The weapon may comprise a low voltage conducted electrical weapon. The low voltage conducted electrical weapon may provide a stimulus signal at a constant voltage. For a stimulus signal applied to a same or constant load impedance, the stimulus signal may be provided at a constant current. In embodiments, a waveform of a stimulus signal may be modified in accordance with different load impedances. In embodiments, modifying the waveform may comprise adjusting a pulse duration by which a pulse of the stimulus signal is provided in order to cause NMI for different load impedances to which the stimulus signal may be provided.

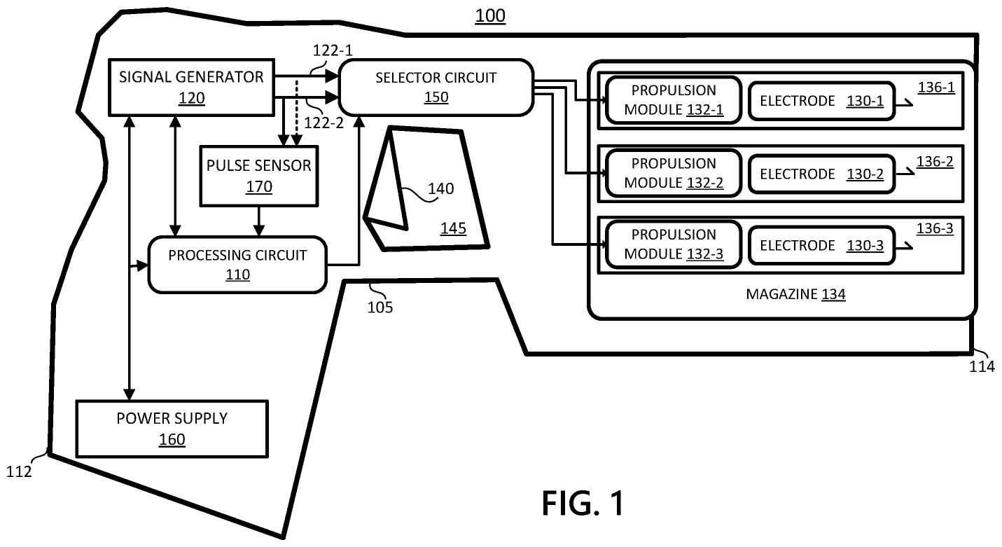

For example, and with reference to FIG. 1, CEW 100 is disclosed. CEW 100 may be similar to, or have similar aspects and/or components with, any conducted electrical weapon discussed herein. CEW 100 may comprise a housing 105 and one or more deployment units 136 (e.g., cartridges). For example, CEW 100 may include a first deployment unit 136-1, a second deployment unit 136-2, and a third deployment unit 136-3. It should be understood by one skilled in the art that FIG. 1 is a schematic representation of CEW 100, and one or more of the components of CEW 100 may be located in any suitable position within, or external to, housing 105. A handle of CEW 100 may comprise housing 105 and one or more of the components of CEW 100 integrated with housing 105. The handle of CEW 100 may be separate from components of CEW 100 that may be selectively coupled to housing 105, such as magazine 134 and deployment units 136.

Housing 105 may be configured to house various components of CEW 100 that are configured to enable deployment of deployment units 136, provide an electrical current to the deployment units 136, and otherwise aid in the operation of CEW 100, as discussed further herein. Although depicted as a firearm in FIG. 1, housing 105 may comprise any suitable shape and/or size. Housing 105 may comprise a handle end 112 opposite a deployment end 114. Deployment end 114 may be configured, and sized and shaped, to receive one or more deployment units 136. Handle end 112 may be sized and shaped to be held in a hand of a user. For example, handle end 112 may be shaped as a handle to enable hand-operation of the CEW by the user. In various embodiments, handle end 112 may also comprise contours shaped to fit the hand of a user, for example, an ergonomic grip. Handle end 112 may include a surface coating, such as, for example, a non-slip surface, a grip pad, a rubber texture, and/or the like. As a further example, handle end 112 may be wrapped in leather, a colored print, and/or any other suitable material, as desired.

In various embodiments, housing 105 may comprise various mechanical, electronic, and/or electrical components configured to aid in performing the functions of CEW 100. For example, housing 105 may comprise one or more control interfaces 140, processing circuits 110, power supplies 160, and/or signal generators 120. Housing 105 may include a guard 145. Guard 145 may define an opening formed in housing 105. Guard 145 may be located on a center region of housing 105 (e.g., as depicted in FIG. 1), and/or in any other suitable location on housing 10. Control interface 140 may be disposed within guard 145. Guard 145 may be configured to protect control interface 140 from unintentional physical contact (e.g., an unintentional activation of a trigger of control interface 140). Guard 145 may surround control interface 140 within housing 105.

In various embodiments, control interface 140 may include a user control interface. A user control interface may be configured to be manually actuated by a user of CEW 100. A user control interface may include a trigger. A user control interface may be coupled to an outer surface of housing 105, and may be configured to move, slide, rotate, or otherwise become physically depressed or moved upon application of physical contact. For example, control interface 140 may be actuated by physical contact applied to control interface 140 from within guard 145. Control interface 140 may comprise a mechanical or electromechanical switch, button, trigger, or the like. For example, control interface 140 may comprise a switch, a pushbutton, and/or any other suitable type of trigger. Control interface 140 may be mechanically and/or electronically coupled to processing circuit 110. In response to control interface 140 being actuated (e.g., depressed, pushed, etc. by the user), processing circuit 110 may enable deployment of one or more deployment units 136 from CEW 100, as discussed further herein.

In various embodiments, power supply 160 may be configured to provide power to various components of CEW 100. For example, power supply 160 may provide energy for operating the electronic and/or electrical components (e.g., parts, subsystems, circuits, etc.) of CEW 100 and/or one or more deployment units 136. Power supply 160 may provide electrical power. Providing electrical power may include providing a current at a voltage. Power supply 160 may be electrically coupled to processing circuit 110 and/or signal generator 120. In various embodiments, in response to control interface 140 comprising electronic properties and/or components, power supply 160 may be electrically coupled to control interface 140. In various embodiments, in response to control interface 140 comprising electronic properties or components, power supply 160 may be electrically coupled to control interface 140. Power supply 160 may provide an electrical current at a voltage. Electrical power from power supply 160 may be provided as a direct current (“DC”). Electrical power from power supply 160 may be provided as an alternating current (“AC”). Power supply 160 may include a battery. The energy of power supply 160 may be renewable or exhaustible, and/or replaceable. For example, power supply 160 may comprise one or more rechargeable or disposable batteries. In various embodiments, the energy from power supply 160 may be converted from one form (e.g., electrical, magnetic, thermal) to another form to perform the functions of a system.

Power supply 160 may provide energy for performing the functions of CEW 100. For example, power supply 160 may provide the electrical current to signal generator 120 that is provided through a target to impede locomotion of the target (e.g., via deployment unit 20). Power supply 160 may provide the energy for a stimulus signal. Power supply 160 may provide the energy for other signals, including an ignition signal and/or an activation signal, as discussed further herein.

In various embodiments, processing circuit 110 may comprise any circuitry, electrical components, electronic components, software, and/or the like configured to perform various operations and functions discussed herein. For example, processing circuit 110 may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, processing circuit 110 may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, processing circuit 110 may include data buses, output ports, input ports, timers, memory, arithmetic units, counters, and/or the like. A memory of processing circuit 110 may comprise a non-transitory, computer-readable memory.

Processing circuit 110 may be configured to provide and/or receive electrical signals whether digital and/or analog in form. Processing circuit 110 may provide and/or receive digital information via a data bus using any protocol. Processing circuit 110 may receive information, manipulate the received information, and provide the manipulated information. Processing circuit 110 may store information and retrieve stored information. Information received, stored, and/or manipulated by processing circuit 110 may be used to perform a function, control a function, and/or to perform an operation or execute a stored program. For example, processing circuit 110 may receive position information from a position sensor and perform one or more operations based on the position information. Processing circuit 110 may comprise a clock (e.g., clock circuit, circuitry configured to perform operations of a clock, etc.) and perform one or more operations based on a sequence of current times provided via the clock. In embodiments, the clock may comprise one or more of a timer circuit and a counter circuit configured to generate an output signal representing a sequence of current times from which a period or duration of time may be determined by processing circuit 110. The clock may enable an amount of time that has passed since a previous operation was performed (e.g., elapsed time) to be identified by processing circuit 110.

Processing circuit 110 may control the operation and/or function of other circuits and/or components of CEW 100. Processing circuit 110 may receive status information regarding the operation of other components, perform calculations with respect to the status information, and provide commands (e.g., instructions) to one or more other components. Processing circuit 110 may command another component to start operation, continue operation, alter operation, suspend operation, cease operation, or the like. Commands and/or status may be communicated between processing circuit 110 and other circuits and/or components via any type of bus (e.g., SPI bus) including any type of data/address bus.

In various embodiments, processing circuit 110 may be mechanically and/or electronically coupled to control interface 140. Processing circuit 110 may be configured to detect an activation, actuation, depression, input, etc. (collectively, an “activation event”) at control interface 140. In response to detecting the actuation event, processing circuit 110 may be configured to perform various operations and/or functions, as discussed further herein. Processing circuit 110 may also include a sensor (e.g., a trigger sensor) attached to control interface 140 and configured to detect an activation event of control interface 140. The sensor may comprise any suitable mechanical and/or electronic sensor capable of detecting an activation event at control interface 140 and reporting the activation event to processing circuit 110.

In various embodiments, processing circuit 110 may be mechanically and/or electronically coupled to control interface 140 to receive an activation signal. The activation signal may include one or more of a mechanical and/or electrical signal. For example, the activation signal may include a mechanical signal received by control interface 140 and detected by processing circuit 110 as an activation event. Alternately or additionally, the activation signal may include an electrical signal received by processing circuit 110 from a sensor associated with control interface 140, wherein the sensor may detect an activation event of control interface 140 and provide the electrical signal to processing circuit 110. In embodiments, control interface 140 may generate an electrical signal in accordance with an activation event of control interface 140 and provide the electrical signal to processing circuit 110 as an activation signal.

In embodiments, processing circuit 110 may receive the activation signal from a different electrical circuit or device. For example, the activation signal may be received via a wireless communication circuit (not shown). The activation signal may be received from a different electrical circuit or device separate from processing circuit 110 and CEW 100. The activation signal may be received from a different electrical circuit or device external and in communication with processing circuit 110 and CEW 100. For example, the activation signal may be received from a remote-control device in wireless communication with CEW 100 and processing circuit 110 of CEW 100.

In various embodiments, control interface 140 may be repeatedly actuated to provide a plurality of activation signals. For example, a trigger may be depressed multiple times to provide a plurality of activation events of the trigger, wherein an activation signal is detected, received, or otherwise determined by processing circuit 110 each time the trigger is depressed. Each activation signal of the plurality of activation signals may be separately received by CEW 100 via control interface 140.

In various embodiments, control interface 140 may be actuated multiple times over a period of time to provide a sequence of activation signals. Each activation signal of the sequence may be received at a different, discrete time during the period of time. For example, a trigger of CEW 100 may be actuated at a first time during a period of time to provide a first activation signal and again actuated at a second time during the period of time to provide a second activation signal. A sequence of activation signals comprising the first activation signal and the second activation signal may be received by CEW 100 via the trigger during the period of time. CEW 100 may receive the sequence of activation signals via control interface 140 and perform at least one function in response to each activation signal of the sequence.

In embodiments, control interface 140 may be actuated for a duration of time to provide an activation signal for the duration of time. The activation signal may be provided to processing circuit 110 during the duration of time. For example, control interface 140 may be actuated (e.g., depressed) to initiate an activation at a first time and the control interface 140 may continue to be actuated during the duration of time until a second time. Processing circuit 110 may detect the activation signal at the first time in accordance with the actuation of control interface 140. Processing circuit 110 may also detect an end to the activation signal at the second time in accordance with the de-actuation (e.g., release) of control interface 140. During the duration of time, processing circuit 110 may continuously receive the activation signal from control interface 140. During the duration of time, processing circuit 110 may periodically detect the activation signal to confirm that the activation signal continues to be provided during the duration of time. During the duration of time, processing circuit 110 may continuously check (e.g., measure, sample, etc.) a signal received via an electrical connection with control interface 140 to confirm that the signal is consistently received during the duration of time. At the second time, processing circuit 110 may detect the activation signal is no longer received via control interface 140. While the activation signal is received via control interface 140, CEW 100 may be configured to perform at least one function in accordance with receiving and continuing to receive the activation signal for the duration of time. When a first activation signal ends (e.g., is terminated, is no longer detected, is no longer received., etc.) the at least one function may end as well. When a second activation signal is received after the first activation signal, another set of one or more operations may be performed in accordance with receiving the second activation for a second duration of time, different from the first activation signal and a first period of time during which the first activation signal was received. In alternate or additional embodiments, CEW 100 may be configured to automatically perform a plurality of operations, including deploying one or more next electrodes, independent of whether an activation signal continues to be received after CEW 100 deploys a first electrode responsive to initially receiving the activation signal.

In various embodiments, CEW 100 may comprise a pulse sensor configured to detect a pulse delivered to a target by CEW 100. The pulse sensor may be integrated with CEW 100. The pulse sensor may be integrated with a handle of CEW 100. For example, CEW 100 may comprise pulse sensor 170. Pulse sensor 170 may be configured to measure at least one property of a pulse of a stimulus signal provided by CEW 100. Pulse sensor 170 may be configured to measure a current of the pulse of the stimulus signal. Pulse sensor 170 may be configured to measure a current of each pulse of a plurality of pulses by which a stimulus signal is delivered to a target. Pulse sensor 170 may be coupled to one or more output signals 122 of signal generator 120. Alternately or additionally, pulse sensor 170 may be coupled to one or more outputs of selector circuit 150. Pulse sensor 170 may be coupled in series with and/or in parallel with an output of signal generator 120 and/or selector circuit 150. Measuring the current may comprise providing a measured current. For example, a measured current may be provided by pulse sensor 170 to processing circuit 110. In some embodiments, pulse sensor 170 may be further configured to detect a time at which a pulse is initiated. The time may enable pulse sensor 170, processing circuit 110, and/or a combination thereof to determine a period of time over which the pulse is delivered. In embodiments, pulse sensor 170 may provide a timing value that indicates a start time of a pulse to processing circuit 110. In embodiments according to various aspects of the present disclosure, pulse sensor 170 may comprise one or more of a current sensor and a charge sensor.

In various embodiments, processing circuit 110 may be electrically and/or electronically coupled to power supply 160. Processing circuit 110 may receive power from power supply 160. The power received from power supply 160 may be used by processing circuit 110 to receive signals, process signals, and transmit signals to various other components in CEW 100. Processing circuit 110 may use power from power supply 160 to detect an activation event of control interface 140 and generate one or more control signals in response to the detected activation event. The control signal may be based on actuation of control interface 140. The control signal may be an electrical signal.

In various embodiments, processing circuit 110 may be electrically and/or electronically coupled to signal generator 120. Processing circuit 110 may be configured to transmit or provide control signals to signal generator 120 in response to detecting an actuation of control interface 140 (e.g., a trigger of control interface 140). Processing circuit 110 may be configured to transmit or provide control signals to signal generator 120 in response to receiving an activation signal. Multiple control signals may be provided from processing circuit 110 to signal generator 120 in series. In response to receiving the control signal, signal generator 120 may be configured to perform various functions and/or operations, as discussed further herein.

In various embodiments, and with reference again to FIG. 1, signal generator 120 may be configured to receive one or more control signals from processing circuit 110. Signal generator 120 may provide an ignition signal to one or more deployment units 136 based on the control signals. Signal generator 120 may provide a stimulus signal to one or more deployment units 136 based on the control signals. Signal generator 120 may be electrically and/or electronically coupled to processing circuit 110 and/or deployment unit 136. Signal generator 120 may be electrically coupled to power supply 160. Signal generator 120 may use power received from power supply 160 to generate an ignition signal. For example, signal generator 120 may receive an electrical signal from power supply 160 that has first current and voltage values. Signal generator 120 may transform the electrical signal into an ignition signal having second current and voltage values. The transformed second current and/or the transformed second voltage values may be different from the first current and/or voltage values. The transformed second current and/or the transformed second voltage values may be the same as the first current and/or voltage values. Signal generator 120 may temporarily store power from power supply 160 and rely on the stored power entirely or in part to provide the ignition signal. Signal generator 120 may also rely on received power from power supply 160 entirely or in part to provide the ignition signal, without needing to temporarily store power. Signal generator 120 may use power received from power supply 160 to generate a stimulus signal. Signal generator 120 may transform an electrical signal provide from power supply 160 to provide the stimulus signal. Each of an ignition signal and a stimulus signal may be provided as an output signal from signal generator 120. In embodiments, the ignition signal and the stimulus signal may be provided responsive to same or different control signals from processing circuit 110.

Signal generator 120 may be controlled entirely or in part by processing circuit 110. In various embodiments, signal generator 120 and processing circuit 110 may be separate components (e.g., physically distinct and/or logically discrete). Signal generator 120 and processing circuit 110 may be a single component. For example, a control circuit within housing 105 may at least include signal generator 120 and processing circuit 110. The control circuit may also include other components and/or arrangements, including those that further integrate corresponding function of these elements into a single component or circuit, as well as those that further separate certain functions into separate components or circuits.

Signal generator 120 may be controlled by the control signals to generate an ignition signal having a predetermined current value or values. For example, signal generator 120 may include a current source. The control signal may be received by signal generator 120 to activate the current source at a current value of the current source. An additional control signal may be received to decrease a current of the current source. For example, signal generator 120 may include a pulse width modification circuit coupled between a current source and an output of the control circuit. A second control signal may be received by signal generator 120 to activate the pulse width modification circuit, thereby decreasing a non-zero period of a signal generated by the current source and an overall current of an ignition signal subsequently output by the control circuit. The pulse width modification circuit may be separate from a circuit of the current source or, alternatively, integrated within a circuit of the current source. Various other forms of signal generators 120 may alternatively or additionally be employed, including those that apply a voltage over one or more different resistances to generate signals with different currents. In various embodiments, signal generator 120 may include a low-voltage module configured to deliver an electrical current having a lower voltage. The lower voltage may comprise for example, 2,000 volts. In embodiments, CEW 100 may lack a high voltage module or other component required to deliver a high voltage. In such embodiments, CEW 100 may comprise a low voltage CEW.

Responsive to receipt of a signal indicating actuation of control interface 140 (e.g., an activation event), a control circuit provides an ignition signal to one or more deployment units 136. For example, signal generator 120 may provide an electrical signal as an ignition signal to first deployment unit 136-1 in response to receiving a control signal from processing circuit 110. In various embodiments, the ignition signal may be separate and distinct from a stimulus signal. For example, a stimulus signal in CEW 100 may be provided to a different circuit within first deployment unit 136-1, relative to a circuit to which an ignition signal is provided. Signal generator 120 may be configured to generate a stimulus signal. In various embodiments, a second, separate signal generator, component, or circuit (not shown) within housing 105 may be configured to generate the stimulus signal. Signal generator 120 may also provide a ground signal path for deployment units 136, thereby completing a circuit for an ignition signal provided to deployment units 136 by signal generator 120. The ground signal path may also be provided to deployment units 136 by other elements in housing 105, including power supply 160.

Signal generator 120 may generate at least two output signals 122. The at least two output signals 122 may include an ignition signal. The at least two output signals 122 may include a stimulus signal. The at least two output signals 122 may include at least two different voltages, wherein each different voltage of the at least two different voltages is determined relative to a common reference voltage. The at least two signals may include first output signal 122-1 and second output signal 122-2. The first output signal 122-1 may have a first voltage. The second output signal 122-2 may have a second voltage. The first voltage may be different from the second voltage relative to a common reference voltage (e.g., ground, the first voltage, the second voltage, etc.). Selector circuit 150 may couple the first output signal 122-1 and the second output signal 122-2 to deployment units 136. Selector circuit 150 may couple the outputs signals 122 via a conductive interface (not shown) between a handle of CEW 100 and deployment units 136. Selector circuit 150 may be configured to selectively couple output signals 122 to deployment units 136 in accordance with one or more control signals received by selector circuit 150 from processing circuit 110. For example, selector circuit 150 may comprise one or more switches that, in response to one or more controls from processing circuit 110, selectively couple one or more output signals 122 to one or more respective deployment units 136. The at least two output signals 122 may be coupled to separate, respective electrical signal paths within CEW 100. The at least two output signals 122 may be provided to a remote location via separate, respective electrical signal paths between CEW 100 and the remote location. Coupling of the at least two electrical output signals 122 through a load at the remote location may enable an electrical signal to be delivered at the remote location, wherein the electrical signal comprises a current determined in accordance with at least two different voltages of the at least two output signals 122 and a resistance of the load. For example, a stimulus signal may be provided at a remote location in accordance with a first voltage of first output signal 122-1, a second voltage of second output signal 122-2, and a load at the remote location, wherein an amount of current of the stimulus signal is determined in accordance with a resistance of the load and a voltage difference between the first voltage and the second voltage. While shown as a separate element in FIG. 1, selector circuit 150 may be excluded and/or combined with other elements such as processing circuit 110 and/or signal generator 120, according to various aspects of the present disclosure.

In various embodiments, deployment units 136 may comprise propulsion modules 132 and projectiles. The projectiles may include electrodes 130. Each deployment unit of deployment units 136 may comprise a separate propulsion module and projectile. For example, first deployment unit 136-1 comprises first electrode 130-1 and propulsion module 132-1, second deployment unit 136-2 comprises second electrode 130-2 and propulsion module 132-2, and third deployment unit 136-3 comprises third electrode 130-3 and propulsion module 132-3. Providing a signal to an electrode (e.g., providing an ignition signal from a handle of CEW 100 to an electrode of electrodes 130) may comprise providing the signal to the deployment unit in which the electrode is disposed prior to being deployed. The signal may be provided to the electrode via the deployment unit in which the electrode is disposed prior to being deployed. For example, an ignition signal may be provided to an electrode via a propulsion module, which may transform an electrical signal of the ignition signal to a mechanical signal (e.g., force) of the ignition signal, wherein the mechanical signal causes the electrode to be deployed from a deployment unit in which the electrode and the propulsion module are included. As another example, an electrical signal of a stimulus signal may be electrically coupled to an electrode via a housing and/or filament of a deployment unit in which the electrode is included.

In various embodiments, each electrode of electrodes 130 may be configured to provide a single conductive signal path between CEW 100 and a remote location upon deployment. For example, each electrode of the electrodes 130 may comprise a single electrical conductor. Further, each electrode of the electrodes 130 may be coupled to CEW 100 via a respective filament. Each filament may further comprise a single conductor. Accordingly, in various embodiments, each electrode of electrodes 130 may be selectively coupled to one of first output signal 122-1 and second output signal 122-2 at a time. For example, at a given time, first electrode 130-1 may be coupled to either first output signal 122-1 or second output signal 122-2; second electrode 130-2 may be coupled to either first output signal 122-1 or second output signal 122-2; and third electrode 130-3 may be coupled to either first output signal 122-1 or second output signal 122-2. In various embodiments, each electrode of electrodes 130 may either be coupled to a first voltage of first output signal 122-1 or a second voltage of second output signal 122-2 at the given time. In embodiments, at least one electrode of electrodes 130 may be decoupled from signal generator 120. For example, at a given time, first electrode 130-1 may be coupled to one of first output signal 122-1 and second output signal 122-2; second electrode 130-2 may be coupled to another of first output signal 122-1 and second output signal 122-2 different from first electrode 130-1; and third electrode 130-3 may be decoupled from both first output signal 122-1 and second output signal 122-2. As noted above, remote delivery of a current, including a current of a stimulus signal, is determined in accordance with two different voltages provided at a remote location according to various aspects of the present disclosure.

Magazine 134 may be releasably engaged with housing 105. Magazine 134 may include a plurality of firing tubes, where each firing tube is configured to secure one deployment unit of deployment units 136. Magazine 134 may be configured to launch electrodes 130 housed in deployment units 136 installed in each of the plurality of firing tubes of magazine 134. Magazine 134 may be configured to receive any suitable or desired number of deployment units 136, such as, for example, one deployment unit, two deployment units, three deployment units, six deployment units, nine deployment units, ten deployment units, etc.

In various embodiments, propulsion modules 132 may be coupled to, or in communication with respective projectiles in deployment units 136. Propulsion modules 132 may comprise any device, such as propellant (e.g., air, gas, etc.), primer, or the like capable of providing propulsion forces in deployment units 136. The propulsion force may include an increase in pressure caused by rapidly expanding gas within an area or chamber. A propulsion force from each of propulsion modules 132 may be applied to respective electrodes 130 in deployment units 136 to cause the deployment of electrodes 130. Propulsion modules 132 may provide the respective propulsion forces in response to respective deployment units 136 receiving one or more respective ignition signals.

In various embodiments, a propulsion force may be directly applied to a projectile. For example, a first propulsion force may be provided directly to first electrode 130-1 via propulsion module 132-1. Propulsion module 132-1 may be in fluid communication with first electrode 130-1 to provide the propulsion force. For example, the propulsion force from propulsion module 132-1 may travel within a housing or channel of first deployment unit 136-1 to first electrode 130-1. In other embodiments, a propulsion force may be indirectly provided to an electrode. For example, a propulsion module may comprise a piston, wad, or other intermediate component physically disposed between a primer or other propellant, wherein the propulsion force is coupled to the electrode via the intermediate component.

In various embodiments, each projectile of deployment units 136 may comprise any suitable type of projectile. For example, the projectiles may be or include electrodes 130 (e.g., electrode darts). Each electrode of electrodes 130 may include a spear portion, designed to pierce or attach proximate a tissue of a target in order to provide a conductive electrical path between the electrode and tissue. For example, first deployment unit 136-1 may include first electrode 130-1, second deployment unit 136-2 may include second electrode 130-2, and third deployment unit 136-3 may include third electrode 130-3. Electrodes 130 may be deployed from deployment units 136 in series over time. In embodiments, a single electrode (e.g., first electrode 130-1 or second electrode 130-2) launched in response to an ignition signal as further discussed herein.

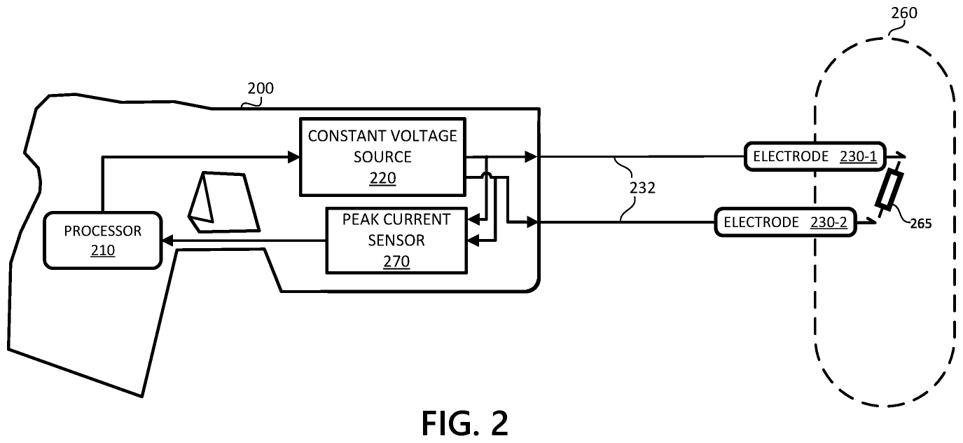

In various embodiments, a conducted electrical weapon may be coupled to a target via two or more deployed electrodes. For example, in accordance with various embodiments and with reference to FIG. 2, an exemplary CEW 200 comprising deployed electrodes is provided. CEW 200 may perform one or more functions of a conducted electrical weapon as further disclosed herein. CEW 200 may perform one or more operations of CEW 100 with brief reference to FIG. 1. CEW 200 may comprise a processor 210. Processor 210 may perform one or more operations of a processing circuit disclosed herein. For example, processor 210 may perform one or more operations of processing circuit 110 with brief reference to FIG. 1. In embodiments, CEW 200 may comprise a constant voltage source 220. Source 220 may be configured to generate stimulus signal comprising a voltage. Source 220 may provide each pulse of a stimulus signal at the voltage. A voltage of the stimulus signal provided to a same impedance of a target by source 220 may not change between pulses. A voltage of the stimulus signal provided to the same impedance of a target by source 220 may not change between while a given pulse is applied. In embodiments, source 220 may provide a stimulus signal comprising a same voltage over time (i.e., constant voltage) to each target to which the stimulus signal is provided. In embodiments, source 220 may comprise a resistance disposed in series with an impedance of a target when a stimulus signal is provided to the target. A value of the resistance may be selected in accordance with a predetermined range of target impedances such that a voltage of a stimulus signal applied to an impedance of a target may further be provided within a predetermined range of applied voltages. Based on relationship between the resistance and a load impedance, the constant voltage value delivered to different, respective targets may be different. However, for a given load impedance of a given target, a voltage of the stimulus signal coupled across the resistance to the given load impedance may remain constant over time. Source 220 may comprise a supply voltage source coupled to apply a constant supply voltage across the resistance and load voltage, thereby enabling a stimulus signal comprising a constant voltage to be applied over time across a same load impedance. The voltage of stimulus signal may be applied in a constant manner over time independent of the specific value of the load voltage. A constant voltage may be applied to generate a stimulus signal for different load impedances coupled to CEW 200. For a same load impedance, each pulse of a stimulus signal having a same voltage may be provided at a same current. Accordingly, source 220 may comprise a constant current source. For a same load impedance, a current value of a stimulus signal applied to the same impedance may be constant for each pulse of the stimulus signal applied to the impedance. For a same load impedance, a current value of a stimulus signal applied to the same impedance may be constant for the respective duration of a pulse of the stimulus signal applied to the impedance. For different impedances of different targets to which a stimulus signal, a different, respective value of the constant current may be applied to each of the different targets. However, for each target, the respective value of the current may be constant while the stimulus signal is provided to a same impedance of a target. A stimulus signal comprising a constant voltage and/or constant current may lack, for example, a high voltage portion for ionizing an air gap and a low voltage portion for delivering a charge to a target. A pulse of a stimulus signal comprising a constant voltage and/or constant current may lack, for example, a voltage and/or current that increases, decreases, or is otherwise provided with a predetermined shape that changes during a time in which the pulse is provided to a same load impedance. Rather, over a continuous period of time in which a stimulus signal is applied to a target, a voltage and/or current of the stimulus signal may be constant. For the duration of a pulse of the stimulus signal applied to a target, the voltage and/or current of the pulse may be constant. As discussed above, the voltage and/or current of the pulse of the stimulus signal may be constant in accordance with the pulse of the stimulus signal being applied to an impedance of the target that remains the same over time. In embodiments, a stimulus signal provided by source 220 may comprise a direct current. A polarity of a voltage applied to a target in accordance with a stimulus signal provided by source 220 may not differ during a duration in which a pulse of the stimulus signal is applied to the target. In embodiments, source 220 may perform one or more operations of signal generator 120 and/or selector circuit 150 with brief reference to FIG. 1. In some embodiments, source 220 may be implemented by signal generator 120 in accordance with one or more control signals provided to signal generator 120 from processing circuit 110. For example, source 220 may comprise signal generator 120 controlled by processing circuit 110 to generate outputs having a same voltage for each of two or more deployed electrodes 130. In embodiments, source 220 may be coupled to receive one or more control signals from processor 210. For example, source 220 may receive one or more controls signals to cause source 220 to generate a pulse. The one or more control signals may control source 220 to begin generating (e.g., initiate) the pulse at a first time and stop generating (e.g., terminate) the pulse at a subsequent time. CEW 200 may further comprise one or more wire-tethered electrodes 230. The wire-tethered electrodes may comprise electrodes 230 coupled to CEW 200 via conductive filaments 232. In response to one or more activation signals, CEW 200 is configured to deploy electrodes 230 toward target 260. A pulse of stimulus signal may be delivered to target 260 via the one or more electrodes 230 and filaments 232. Source 220 may be electrically coupled to target 260 via a conductive signal path provided via electrodes 230 and filaments 232. In embodiments, CEW 200 may correspond to various CEWs disclosed herein, including CEW 100 (with brief reference to FIG. 1).

In embodiments, CEW 200 may comprise a peak current sensor 270. Peak current sensor 270 may perform one or more operations of pulse sensor 170 with brief reference to FIG. 1. Peak current sensor 270 may be coupled to an output of source 220. Peak current sensor 270 may measure a current of a pulse of a stimulus signal delivered to target 260 via electrodes 230 and filaments 232. Peak current sensor 270 may provide a measured current in accordance with a detected current delivered to target 260 from source 220. Target 260 may comprise a load impedance 265. The load impedance 265 (i.e., value of the load impedance) may be determined in accordance with a portion of target 260 coupled between a first electrode 230-1 and a second electrode 230-2 through which a pulse of a stimulus signal may be delivered. For example, load impedance 265 may be determined in accordance with tissue of a target disposed between a first location at which first electrode 230-1 is coupled to the target and a second location at which second electrode 230-2 is coupled to the target. Different portions of target 260 and/or and different targets may comprise different load impedances. For purposes of illustration, impedance 265 is indicated in FIG. 2 via a circuit diagram symbol between respective locations on target 260 at which each first electrode 230-1 and second electrode 230-2 are respectively, electrically coupled to target 260. Stimulus signals comprising constant voltages delivered through different load impedances may further comprise different currents in accordance with the different load impedances. Peak current sensor 270 may be configured to measure a current associated with a particular load impedance 265 to which CEW 200 is coupled. Peak current sensor 270 may be configured to detect a maximum (i.e., peak) current delivered over a period of time. In some embodiments, the period of time may comprise a period of time over which an individual (i.e., lone, single, etc.) pulse of a stimulus signal is provided. Peak current sensor 270 may provide a measured current to processor 210 for subsequent operations performed by processor 210. In embodiments, the measured current may comprise a measured peak current. The measured peak current may comprise a measured peak current for a pulse of a stimulus signal. In accordance with the measured current, processor 210 may perform one or more operations to set one or more properties of a pulse to account for load impedance 265. For example, and including as further discussed below, processor 210 may select a pulse duration of a pulse of the stimulus signal. In some embodiments, the selected pulse duration may be further associated with a predetermined charge.

Embodiments according to various aspects of the present disclosure enable a safe and effective stimulus signal to be provided from a conducted electrical weapon using a relatively low voltage. By reducing the voltage and current of a stimulus signal, components of a conducted electrical weapon required to provide the stimulus signal may also be reduced. In turn, this enables a housing of a conducted electrical weapon to be smaller compared to a conducted electrical weapon configured to generate a high voltage stimulus signal or a stimulus signal comprising a high voltage portion.

For a stimulus signal that is provided with a lower voltage, an impedance of a target, also referred to herein as a load impedance, may have a greater impact on a current of stimulus signal than a current of a stimulus signal provided at a higher voltage. Current I provided by a stimulus signal is equal to a voltage V of the stimulus signal divided by the load impedance R (I=V/R). An amount of charge delivered to the load impedance (i.e., target) may be equal to the current multiplied by a duration (i.e., period of time) over which the current is applied to the load impedance.

In embodiments, delivered charge may correlate to effectiveness of a stimulus signal. In order to cause NMI, a pulse of a stimulus signal provided by a conducted electrical weapon may have a target charge (i.e., target charge to be delivered to a target). The target charge may be selected for delivery by the conducted electrical weapon in order to cause NMI. The target charge may comprise a minimum charge designed to cause NMI. The target charge may comprise a charge configured to excite a muscle of a target to cause NMI. The target charge may comprise a range of charges over which the pulse of the stimulus signal is designed to cause NMI. The target charge may alternately or additionally comprise a maximum charge. The maximum charge may be established by properties of the conducted electrical weapon used to generate the pulse of the stimulus signal. Alternately or additionally, the maximum charge may be established in order to avoid impacting electrical signals associated with other parts of a body of a target other than (muscles) associated with locomotion.

In embodiments, a load impedance may vary in accordance with various factors. For example, a load impedance may be determined in accordance with characteristics of the target's tissue between two electrodes coupled to the target and/or the characteristics of the target's tissue at each location at which an electrode of the two electrodes contacts the target's tissue. As the load impedance increases, a current delivered via a same voltage decreases. As the load impedance increases, a charge delivered via a same current over a same period of time decreases. At a high voltage, these difference can be minimal for different load impedances (I=large V/R, where large V is greater than 20 kV, for example). However, the difference in current and charge provided to different load impedances via a same voltage increases when relatively lower voltages are employed (I=lower V/R, where lower V is less than 5 kV, 2 kV, or 1 kV, for example). Embodiments according to various aspects of the present disclosure enable a relatively lower voltage to be employed while still providing a target charge. Such embodiments enable a stimulus signal to be further provided for different load impedances, while maintaining safety and effectiveness of the stimulus signal.

In embodiments, physiological aspects of a load impedance may also impact effectiveness of a pulse of a stimulus signal. For example, stimulation of a tissue of a target may be impacted in accordance with a duration over which a pulse is applied to the tissue, as well as a strength (e.g., amplitude) of the current of the pulse. A shorter duration of a pulse may require the pulse to have a higher amplitude in order to excite (e.g., stimulate) a target tissue. Inversely, a pulse having a lower current amplitude may be required to be applied over a longer duration in order to excite the target tissue. In order to excite the tissue, a relationship between the current amplitude of a pulse and a duration of the pulse may be disproportionate. For example, in order for a first pulse having a first current amplitude (A) and a second having a second current amplitude double the first current amplitude (2A) to each be effective, the duration (T) of the first pulse may need to be greater than twice the duration of the second pulse (>2T). A relationship between a current amplitude and a duration required to excite a tissue of a target may be non-linear. Over a range of increasing pulse durations, an amplitude of the current of the pulse required to equally excite a target tissue may decrease in a non-linear manner. The amplitude of the current may decrease in a non-linear manner in order for combinations of the decreasing current amplitude and increasing pulse durations to effectively excite a same target tissue. Applying a constant charge via increasing pulse durations may decrease effectiveness of the delivered charge. Embodiments according to various aspects of the present disclosure enable different pulse durations to equally excite target tissue, despite differences in physiological responses of the target tissue to such different pulse durations. Embodiments according to various aspects of the present disclosure also enable a stimulus signal to be applied using a lower voltage while also minimizing a pulse duration necessary to safely and effectively excite target tissue to cause NMI. In embodiments according to various aspects of the present disclosure, shorter and longer durations of pulses of stimulus signals may be applied while retaining a same effectiveness on target tissue.

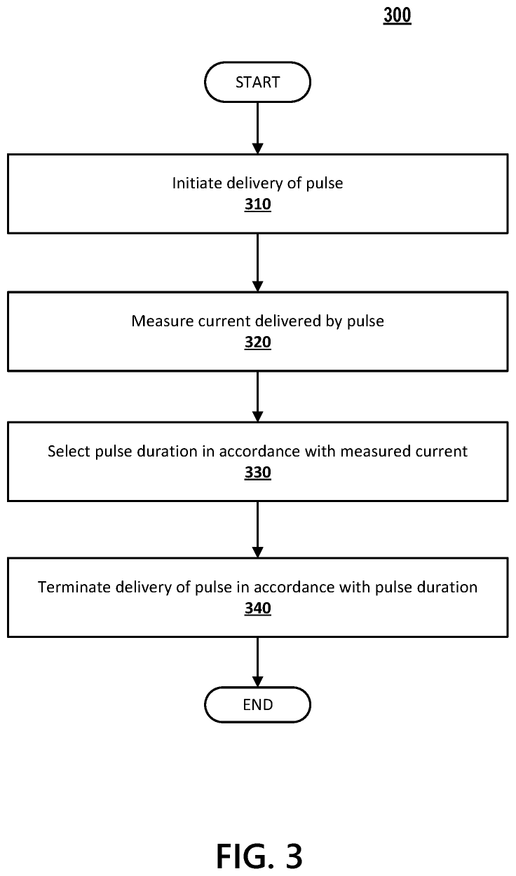

In embodiments, a method for generating a pulse using a lower voltage is provided. The method may compensate for different load impedances coupled to a conducted electrical weapon. The method may compensate for different charges necessary to excite a load for different current amplitudes or durations. For example, and with brief reference to FIG. 3, method 300 comprises an example set of one or more operations that may be performed to compensate for different load impedances coupled to a conducted electrical weapon. The one or more operations may be performed by the conducted electrical weapon. For example, method 300 may be implemented by a conducted electrical weapon as disclosed herein, including CEW 100 and/or CEW 200 with brief reference to FIGS. 1-2. In embodiments, method 300 may comprise one or more of initiating delivery of a pulse 310, measuring a current delivered by the pulse 320, selecting a pulse duration in accordance with the measured current 330, and terminating delivery of pulse in accordance with the pulse duration 340. In embodiments, setting the duration of a stimulus signal may comprise one or more of selecting a pulse duration in accordance with the measured current 330 and/or terminating delivery of pulse in accordance with the pulse duration 340.

In some embodiments, delivery of a pulse may be initiated. Initiating delivery of a pulse 310 may comprise providing the pulse to a load. The pulse may comprise a pulse of a stimulus signal. Initiating delivery of the pulse 310 may comprise starting, by a conducted electrical weapon, to generate the pulse. For example, processing circuit 110 may instruct signal generator 120 to generate a pulse of a stimulus signal with brief reference to FIG. 1. Alternately or additionally, processor 210 may instruct source 220 to begin outputting the pulse with brief reference to FIG. 1. Alternately or additionally, initiating delivery of a pulse may comprise closing a circuit between a source of a stimulus signal and one or more electrodes by which a pulse of the stimulus signal is provided to a target. For example, processing circuit 110 may instruct selector circuit 150 to close one or more switches to couple one or more output signals 122 from signal generator 120 to one or more electrodes 130.

In embodiments, initiating delivery of the pulse may comprise increasing a voltage provided to a load. The voltage may increase from a first value to a second value higher than the first value. For example, a voltage provided to a load from a conducted electrical weapon may increase from a minimum value to a low voltage value. In some embodiments, the minimum value may comprise one of less than 50 volts, less than 5 volts, or 0 volts. The minimum voltage may comprise a voltage of the stimulus signal provided during a rest period of the stimulus signal. The minimum voltage may comprise a voltage of the stimulus signal provided between separate, sequential pulses of the stimulus signal. The low voltage value may comprise one or more of 500 volts; at least 1000 volts; between 1000 and 5000 volts; at least 2000 volts; between 2000 and one of 500 volts or 1000 volts, at least 5000 volts; between 5000 volts and one of 500, 1000, or 2000 volts; or less than 5000, 2000, or 1000 volts. In embodiments, a shape of the pulse may comprise a square wave. The square wave may be provided between a first time at which delivery of the pulse is initiated and a second, subsequent time at which delivery of the pulse is terminated. Between the first and second times, a voltage and/or current of the pulse may be constant. In embodiments, initiating delivery of the pulse may comprise starting to generate the pulse. Terminating the delivery of the pulse may alternately or additionally comprise stopping the generating of the pulse.

In embodiments, initiating delivery of a pulse 310 may comprise electrically coupling the pulse to a load. The load may comprise a portion of a target. For example, CEW 200 may couple a pulse to load 260 via a first electrode 230-1 and a second electrode 230-2 with brief reference to FIG. 2. Coupling the pulse to the load may be performed after one or more electrodes have been deployed to the target. For example, initiating delivery of the pulse 310 may comprise coupling the pulse to load impedance 265 after first electrode 230-1 and second electrode 230-2 have been launched from a housing of CEW 200 to load 260 with brief reference to FIG. 2.

In embodiments, initiating delivery of a pulse 310 may comprise coupling a pulse of a stimulus signal to the load at a first point in time. Prior to the point in time, the stimulus signal may not be provided to the pulse. A period of time prior to the point in time may comprise a rest period between the pulse and a last point in time at which a previous pulse was provided. The period prior to the point in time may comprise a rest period between the pulse and a last point in time at which a previous pulse was provided. Initiating delivery of the pulse may comprise generating the pulse at the first point in time.

In embodiments, initiating delivery of the pulse 310 may comprise providing a pulse at a constant voltage. For example, each pulse of a stimulus signal may be generated with a same supply voltage value. A source of the stimulus signal, such as signal generator 120 or source 220 may provide one or more outputs that have a same voltage. For a same impedance of a target to which the stimulus signal is delivered, the voltage of each of the outputs may be constant. Each pulse of a stimulus signal may be provided at a same voltage. For a duration in which a pulse of the stimulus signal is delivered to a same impedance of a target, a voltage at which the pulse is delivered to the same impedance may be constant. The voltage of a pulse of a stimulus signal may not be modified independent of a load impedance to which the pulse of the stimulus signal is provided to the target. In accordance with providing a pulse of a stimulus signal at a constant voltage, components required to provide the stimulus signal may be simplified and/or reduced in size.

In embodiments, initiating delivery of the pulse 310 may comprise providing a pulse at a constant current. The current of stimulus signal may be current in accordance with a same voltage being used to provide the stimulus signal. The current of the stimulus signal may be further constant in accordance with applying the stimulus signal to a constant load impedance. The constant load impedance may comprise a same portion of a target to which each of a series of pulses of a stimulus signal are delivered at a same voltage. For same load impedances for each pulse, a same or constant current may be further provided via a stimulus signal comprising each pulse. The pulse may have a same current as other pulses in a series of pulses when each pulse is applied across a same load impedance at a same voltage (i.e., constant voltage). The current of a pulse of a stimulus signal may not be modified independent of a load impedance and voltage by which the stimulus signal is provided. However, as discussed above, a value of a constant current may differ in accordance with different load impedances to which the pulse is applied. Such different load impedances may comprise different portions of a same target and/or different targets in embodiments according to various aspects of the present disclosure.

In embodiments, a current of the pulse may be measured. Measuring the current delivered by the pulse may comprise measuring a current value of the pulse. Measuring the current delivered by the pulse 320 may comprise detecting a current value associated with the current of the pulse. Measuring a current delivered by the pulse 320 may comprise coupling the pulse to a pulse sensor. For example, pulse sensor 170 may measure a current of a pulse output from signal generator 120 or selector circuit 150 with brief reference to FIG. 1. Measuring the current delivered by the pulse 320 may comprise measuring the current of the pulse to provide a measured current. Measuring the current delivered by the pulse 320 may comprise providing the measured current, also referred to as the measured current value, for one or more subsequent operations of method 300.

In embodiments, measuring the current of the pulse 320 may be automatically performed in accordance with initiating delivery of the pulse 310. The current of the pulse may be measured responsive to initiating delivery of the pulse. For example, pulse sensor 170 may be continuously measuring a value of a current of a signal coupled to an input of the pulse sensor. Alternately or additionally, pulse sensor 170 may be controlled by processing circuit 110 to measure a current of a pulse concurrently or subsequently to controlling signal generator 120 and/or selector circuit 150 to initiate delivery of the pulse.

In embodiments, measuring the current of the pulse 320 may be performed while the pulse is delivered. For example, the current of the pulse may be measured upon delivery of the pulse and prior to termination of the pulse. The current of the pulse may be measured after delivery of the pulse has been initiated and prior to termination of the pulse. The current of the pulse may be measured while the pulse is being delivered. The current of the pulse may be measured while the pulse is generated. For example, pulse sensor 170 may measure a current of the pulse while a voltage of the pulse is output by signal generator 120.

In embodiments, the current of the pulse may be measured over time. For example, the current of the pulse may be measured during a first set of microseconds over which the pulse is delivered. In some embodiments, the first set of microseconds may comprise the first ten microseconds over which the pulse is delivered, the first twenty microseconds over which the pulse is delivered, or within twenty microseconds after delivery of the pulse is initiated. A processor or other elements of a conducted electrical weapon may be configured to measure the current upon or shortly after delivery of a pulse is initiated.

In embodiments, measuring the current delivered by the pulse 320 may comprise measuring a peak current of the pulse. For example, a series of current measurements may be performed over time to generate a series of current measurement values. Measuring the current of the pulse 320 may comprise identifying a maximum current value of the series of current measurement values. The peak current of the pulse may comprise the maximum current value identified from the series of current measurement values. In other embodiments, other current values may be identified in accordance with a plurality of current measurements of a pulse, including an average current value or mean current value. In such embodiments, measuring the current of the pulse may comprise providing the average current value or mean current value for one or more subsequent operations of method 300.

In embodiments, measuring the current delivered by the pulse 320 may comprise measuring a charge of the pulse. The charge of the pulse may comprise a current of the pulse delivered over a period of time. Measuring the charge may comprise detecting the charge provided in accordance with a current of the pulse over a period of time. The period of time may comprise a predetermined period of time. For example, the predetermined period of time may comprise a first set of microseconds over which the pulse is delivered. The first set of microseconds may comprise a first microsecond in which the pulse is delivered, along with an initial period of time after delivery of the pulse is initiated. Based on the known period time and a charge measured over the known period of time, an average value of the current may be determined. In some embodiments, the charge may be provided for one or more subsequent operations of method 300. Alternately or additionally, a measuring the charge may further comprise determining a current value based on the measured charge. This current value may then be provided for one or more subsequent operations of method 300. In some embodiments, however, measuring the current 320 may be performed independent of a charge applied via a stimulus signal. In such embodiments, a value of a charge delivered to a target may not be detected or may not be required to be detected in order for operations further disclosed herein to be performed.

In embodiments, selecting a pulse duration may be performed. Selecting the pulse duration may provide a selected pulse duration. The pulse duration may be selected among a plurality of possible pulse durations. The plurality of pulse durations may comprise a range of pulse durations between a minimum pulse duration and a maximum pulse duration. In various embodiments, the pulse duration may be varied in accordance with a load impedance of a plurality of different load impedances to which a conducted electrical weapon is coupled. The load impedance of the plurality of load impedances may be identified in accordance with a current measured upon measuring the current delivered by the pulse. The circuit of the conducted electrical weapon through which the stimulus signal is delivered may be arranged such that measured currents within a range of measured currents correlate to respective, predetermined load impedances. In such embodiments, measuring a current may comprise identifying a load impedance of a target in accordance with a predetermined relationship between measured currents and load impedance values. In embodiments, the load impedance of the plurality of load impedances may be identified independent of a charge delivered to the load impedance over a period of time in which the current is measured. The pulse duration of a plurality of different pulse durations may be selected in accordance with the current measured, also referred to herein at the measured current. For example, method 300 may comprise selecting a pulse duration in accordance with the measured current 330.

In embodiments, method 300 may comprise selecting a pulse duration responsive to measuring 330. The pulse duration may be selected automatically in accordance with measuring the current delivered by the pulse 330. For example, processing circuit 110 may automatically select a pulse duration responsive to receiving a measured current from pulse sensor 170 or measuring the current in accordance with one or more current values received from pulse sensor 170. Alternately or additionally, processor 210 may automatically select a pulse duration responsive to receiving a measured current from peak current sensor 270 or measuring the current in accordance with one or more current values received from peak current sensor 270.

In embodiments, selecting a pulse duration 330 may comprise selecting the pulse duration in accordance with the measured current. Measuring 320 may provide a measured current on which the pulse duration may be subsequently selected. The measured current may be processed in various manners to select the pulse duration. The measured current may be associated with a pulse duration among a plurality pulse durations by which a stimulus signal may be provided by a conducted electrical weapon. In embodiments, each of a plurality of different measured currents may be associated with a respective one a plurality of different pulse durations. A relationship between a measured current and a pulse duration may be unique such that each pulse duration of a plurality of durations is selected in accordance with a different respective measured current of a plurality of measured currents. The relationship may be unique for a plurality of measured currents across a range of corresponding pulse durations. Alternately or additionally, subsets of measured currents may be respectively associated with different pulse durations, but measured currents within a respective subset of measured currents may be associated with a same pulse duration according to various aspects of the present disclosure.

In embodiments, selecting a pulse duration may comprise increasing a pulse duration relative to a minimum pulse value. For a maximum measured current, a selected pulse duration may comprise a minimum pulse duration. For measured current less than the maximum measured current value, the selected pulse duration may comprise a pulse duration greater (i.e., longer than) the minimum pulse value. Selecting the pulse duration may comprise adjusting the pulse duration in accordance with a load impedance among a plurality of load impedances to which the conducted electrical weapon is coupled.

In embodiments, selecting the pulse duration 330 may comprise performing matching the measured current with a predetermined pulse duration. For example, a table correlating measured currents to corresponding pulse durations may be provided. The table may be stored in a processor of a conducted electrical weapon and/or accessed from a memory of the conducted electrical weapon by such a processor. A measured current generated upon performing measuring 320 may be used as index relative to this table to select a corresponding pulse duration among a plurality of pulse durations stored in the table. Matching the measured current to a current among the plurality of currents in the table may enable a corresponding pulse duration to be identified. Selecting the pulse duration 330 may comprise providing a selected pulse duration comprising the corresponding pulse duration.

In other embodiments, selecting the pulse duration 330 may comprise calculating the pulse duration. The pulse duration may be selected in accordance with a predetermined formula. For example, processing circuit 110 may apply a measured current to one or more computer-readable instructions that, upon execution, apply a formula to the measured current to generate the pulse duration. Selecting the pulse duration 330 may comprise providing a selected pulse duration comprising the calculated pulse duration.

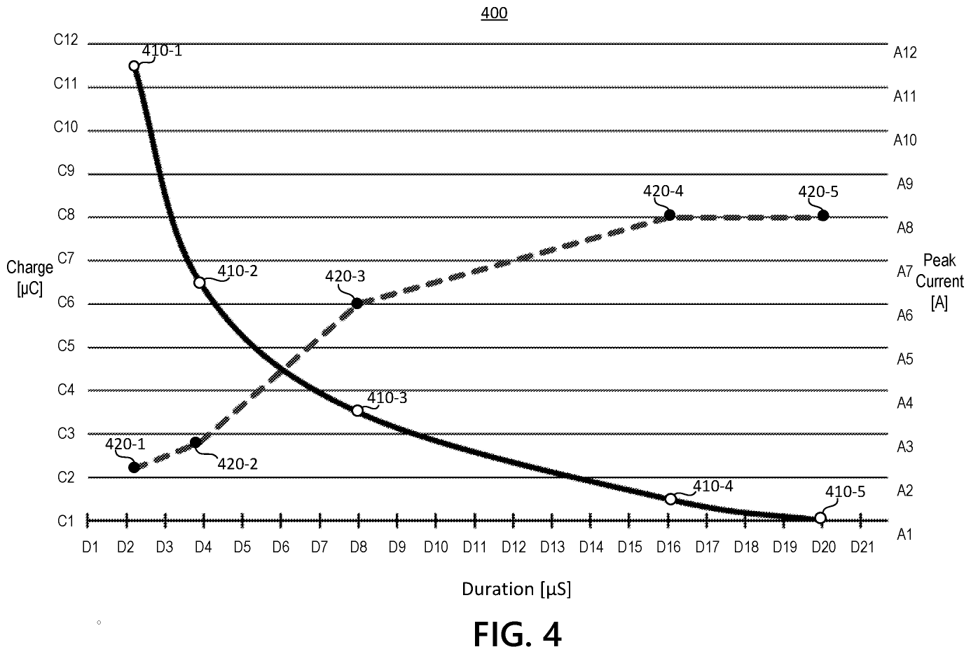

In embodiments, selecting a pulse duration 330 may comprise increasing a charge provided by the pulse. The charge may be increased relative to a charge provided by a prior pulse. For example, a first iteration of method 300 may generate a first pulse having a first charge. Upon execution of a second iteration of method 300 to generate a second subsequent pulse, an increased current may be measured for the second pulse. In accordance with the increased current, a second pulse duration may be selected such that a same charge may be provided via each of the first and second pulses. However, and in some embodiments, a same charge for different currents may not be as effective at causing NMI due to physiological properties of a load impedance. In such embodiments, a second pulse duration may be selected that provides an increased charge relative to the first pulse in order to ensure effectiveness of the second pulse provided at the different measured current. The increased charge may comprise a minimum charge associated with stimulating a target at the second, increased measured current. Example pulse durations associated with different charges are further discussed herein in the context of FIG. 4.

In embodiments, selecting a pulse duration 330 may comprise decreasing a charge provided by the pulse. The charge may be decreased relative to a charge provided by a prior pulse. For example, a first iteration of method 300 may generate a first pulse having a first charge. Upon execution of a second iteration of method 300 to generate a second subsequent pulse, a decreased current may be measured for the second pulse. In some embodiments, and in accordance with the decreased current, a second pulse duration may be selected to provide a second charge equal to the first charge of the first pulse. However, and in other embodiments, a same charge for different currents may use more charge than necessary to stimulate a target tissue. In such embodiments, a second pulse duration may be selected that provides a decreased charge relative to the first pulse in order to minimize a charge applied to a load while maintaining effectiveness of the second pulse provided at the different measured current. Example pulse durations associated with different charges are further discussed herein in the context of FIG. 4.

In embodiments, selecting the pulse duration may be performed while the pulse that was measured while measuring 320 continues to be generated. The pulse duration may be selected prior to elapse of the pulse duration measured from a point in time at which delivery of the pulse was initiated. For example, a selected pulse duration of 160 microseconds (0) may be selected prior to the elapse of 100 μS or less since delivery of the measured pulse was initiated, and also while the pulse measured to continues to be delivered to a target. The pulse duration may be selected a non-zero period of time before a corresponding time since the initial delivery of the pulse has elapsed. In embodiments, the pulse duration may be selected independent of an amount of charge delivered at a point in time at which the current is measured. In embodiments, the pulse duration may be selected independent of a charge delivered at a point in time at which the duration is selected. In accordance with selecting the pulse duration while the pulse is still being provided, accuracy of a charge provided by the same pulse may be enhanced. Such an arrangement may prevent differences in measured currents between a first and second pulses from impacting a charge applied via the second pulse in accordance with a different current measured for the first pulse.

In embodiments, delivery of a pulse may be terminated. The delivery may be terminated in accordance with a pulse duration. For example, method 300 may comprise terminating delivery of a pulse in accordance with the pulse duration 340. The pulse duration may be a selected pulse duration provided responsive to selecting 330. Terminating delivery of the pulse may comprise tracking a period of time over which a pulse has been delivered. The period of time may comprise a time elapsed since the pulse was initiated. For example, a tracked period of time may comprise a period of time since the pulse was first delivered in accordance with initiating delivery of the pulse 310.

In embodiments, terminating delivery of a pulse may comprise determining that a period of time over which the pulse has been delivered is equal or greater than a selected pulse duration. A period of time over which a pulse is delivered may be continuously compared to the selected pulse duration. When the period of time is equal or greater than the pulse duration, delivery of the pulse may be terminated.

In embodiments, terminating delivery of the pulse may comprise decreasing a voltage provided to a load. The voltage may decrease from a second value to a first value less than the second value. For example, a voltage provided to a load from a conducted electrical weapon may decrease to a minimum value from a low voltage value. In some embodiments, the minimum value may comprise one of less than 50 volts, less than 5 volts, or 0 volts. In embodiments, the voltage may decrease by at least 2000 volts, at least 1000 volts, or at least 50 volts.

In embodiments, the pulse terminated at terminating 340 may be a same pulse for which a current was measured upon measuring 340. The pulse may continue to be generated by a conducted electrical weapon until terminating 340 is performed. In other embodiments, terminating 340 may comprise terminating the pulse in accordance with a current measured and/or a pulse duration selected relative to a prior pulse different from a pulse terminated upon terminating 340. For example, a pulse terminated at terminating may be a first pulse, wherein the duration of the first pulse may be set based on measurement of a second, prior pulse delivered prior to the first pulse. Such an alternate arrangement may provide additional processing time for selecting a pulse duration and/or permit a stimulus signal to be generated in parallel with measuring current and/or selecting a pulse.

In embodiments, and responsive to terminating delivery of the pulse, method 300 may end. A conducted electrical weapon by which method 300 is performed may be configured to repeat method 300 to provide another pulse of a stimulus signal at a subsequent point in time. Upon repeating method 300, a different pulse duration may be selected in accordance with a measured current. The different pulse duration may be greater than or less than a pulse duration applied to terminate a previous pulse delivered by a same conducted electrical weapon. In embodiments, the pulse may differ in accordance with a stimulus signal being coupled to a different load impedance and, accordingly, the measurement of a different current (i.e., different current value) by the conducted electrical weapon.

In embodiments, different pulse durations may be selected for different measured currents. The different pulse durations may be selected in accordance with repeated execution of selecting 330 with brief reference to FIG. 3. The different pulse durations may be selected from a range of pulse durations for which a pulse of a stimulus signal may be applied by a conducted electrical weapon. The conducted electrical weapon may comprise a conducted electrical weapon as disclosed herein, including CEW 100 and/or CEW 200 with brief reference to FIGs. 1-2. An example basis for selecting different pulse durations in accordance with different measured currents is shown in FIG. 4. FIG. 4 illustrates an example relationship 400 that may be used to select a pulse duration from a range of pulse durations 420 in accordance with a measured current from a range of measured currents 410 in accordance with various aspects of the present disclosure. In embodiments, relationship 400 may be predetermined. The conducted electrical weapon may be programmed to set pulse durations for a plurality of measured currents in accordance with relationship 400. In embodiments, relationship 400 may be implemented by a conducted electrical weapon based on matching currents from range of currents 410 with corresponding pulse durations from range of pulse durations 420, calculating pulse durations from range of pulse durations 420 based matching currents from range of currents 410, or otherwise identifying pulse durations from range of pulse durations 420 relative to corresponding currents from range of currents 410 as discussed elsewhere herein.

In embodiments, range of measured currents 410 may comprise a series of currents that may be measured by a conducted electrical weapon. A current within range 410 may be measured by a conducted electrical weapon upon measuring the current delivered by a pulse of a stimulus signal. For example, measuring a current delivered by a pulse 320 may measure a current within range 410. Example current values for range 410 are shown in the right vertical axis of FIG. 4. In embodiments, range 410 may comprise first measured current 410-1, second measured current 410-2, third measured current 410-3, fourth measured current 410-4, and/or fifth measured current 410-5. In embodiments, range 410 may increase from the fifth measured current 410-5 to the first measured current 410-1. In accordance with such an increase, first measured current 410-1 may comprise a measured current value greater than second measured current 410-2. This relationship may be repeated by each sequentially subsequent pair of adjacent measured currents through fifth measured current 410-5. In embodiments, range 410 may comprise a range of current values between 0.4 amperes (A) and 2.5 A. In embodiments, the ampere values illustrated in the right vertical axis of FIG. 4 may start at 0.4A and increment 0.2A per unit indicated along the axis. The measured current values represented along the right vertical axis in FIG. 4 may increase for each unit increment from A1 to A12, wherein A12 has a greater measured current value than A1. For example, A1 may equal 0.4 A, A2 may equal 0.6A, A3 may equal 0.8A, A4 may equal 1.0A, A5 may equal 1.2A, A6 may equal 1.4A, A7 may equal 1.6A, A8 may equal 1.8A, A9 may equal 2.0A, A10 may equal 2.2A, All may equal 2.4A, and A12 may equal 2.6 A. In other embodiments, range 410 may comprise other ranges of current values according to various aspects of the present disclosure.

In embodiments, range 410 may be greater than a minimum measured current (e.g., fifth measured current 410-5). The minimum measured current may be determined in accordance with an expected range of load impedances to which a conducted electrical weapon may be coupled. Alternately or additionally, a minimum measured current may be determined in accordance with one or more components of a CEW used to measure the current. For example, a minimum measured current may be determined in accordance with a property of each of one or more of processing circuit 110, signal generator 120, pulse sensor 170, processor 210, voltage source 220, and/or peak current sensor 270 with brief reference to FIG. 1-2. In some embodiments, a minimum measured current may be determined in accordance with a maximum load impedance of a target of a conducted electrical weapon and a predetermined voltage by which a pulse of stimulus signal may be applied. In embodiments, a minimum measured current may comprise a current value equal or greater than 0.2 A, 0.3A, 0.4 A, 0.6 A, or less than 0.8 A. In some embodiments, a minimum measured current may comprise a minimum current threshold value. For measured currents below threshold value, for example, one or more of processing circuit 110, signal generator 120, pulse sensor 170, processor 210, voltage source 220, and/or peak current sensor 270 may indicate an error condition or other information indicating that a measured current is below a predetermined range of expected currents. In some embodiments, such a condition or information may further be used to indicate that a conducted electrical weapon is not coupled to a target and/or a predetermined type of target.

In embodiments, range 410 may be less than a maximum measured current. The maximum measured current may comprise, for example, first measured current 410-1. The maximum measured current may be determined in accordance with expected range of load impedances to which a conducted electrical weapon may be coupled and/or one or more components of a CEW used to measure the current. For example, a maximum measured current may be determined in accordance with a property of each of one or more of processing circuit 110, signal generator 120, pulse sensor 170, processor 210, voltage source 220, and/or peak current sensor 270 with brief reference to FIG. 1-2. In some embodiments, a maximum measured current may be determined in accordance with a minimum load impedance of a target of a conducted electrical weapon and a predetermined voltage by which a pulse of stimulus signal may be applied. In embodiments, a maximum measured current may comprise a current value equal or less than 2.5 A, 2.0 A, or greater than 1.75 A. In some embodiments, a maximum measured current may comprise a maximum current threshold value. For measured currents above the threshold value, for example, one or more of processing circuit 110, signal generator 120, pulse sensor 170, processor 210, voltage source 220, and/or peak current sensor 270 may indicate an error condition or other information indicating that a measured current exceeds a predetermined range of expected currents. In some embodiments, such a condition or information may further be used to indicate that a conducted electrical weapon is not coupled to a predetermined type of target. In embodiments, range 410 may comprise current values between a minimum measured current and a maximum measured current.

In embodiments, a range 420 of pulse durations may comprise a series of pulse durations that may be applied by a conducted electrical weapon to generate a pulse. The conducted electrical weapon may be operable to apply each of the pulse durations of range 420 to a pulse of a stimulus signal. Each pulse duration within range 420 may comprise a non-zero, continuous period of time. A pulse duration within range 420 may be selected by a conducted electrical weapon upon selecting a pulse duration in accordance with a measured current. For example, selecting a pulse duration in accordance with a measured current 330 may select a pulse duration within range 420. Example pulse durations for range 420 are shown in the horizontal axis of FIG. 4. Range 420 may comprise first pulse duration 420-1, second pulse duration 420-2, third pulse duration 420-3, fourth pulse duration 420-4, and/or fifth pulse duration 420-5. In embodiments, range 420 may increase from the first pulse duration 420-1 to the fifth pulse duration 420-5. In accordance with such an increase, first pulse duration 420-1 may comprise a duration less than second measured duration 420-2. This relationship may be repeated by each sequentially subsequent pairs of adjacent pulse durations in range 420 through fifth pulse duration 420-5. In embodiments, range 420 may comprise a range of duration values between 20 μS and 200 μS. In embodiments, the duration values illustrated along the horizontal axis of FIG. 4 may start at 10 μS and increment μS per indicated unit. The duration values may sequentially increase for each unit from D1 to D21, wherein D21 has a greater measured current value than D1. For example, D1 may equal 10 μS and D21 may equal 210 μS. Each indicated increment D2-D20 may sequentially increase by 10 μS relative to the adjacent unit, starting from D1 (D2=20 μS, D3=30 μS, etc.) In other embodiments, range 420 may comprise other ranges of duration values according to various aspects of the present disclosure.

In embodiments, range 420 may be greater than a minimum pulse duration. For example, each duration within range 420 may be equal or greater than first pulse duration 420-1. The minimum pulse duration may be determined in accordance a maximum measured current that may be applied to a range of load impedances to which a conducted electrical weapon may be coupled. Alternately or additionally, a minimum pulse duration may be determined in accordance with one or more components of a CEW used to measure the current. For example, a minimum pulse duration may be determined in accordance with processing speed of processing circuit 110 and/or processor 210. The minimum pulse duration may be equal or greater than a minimum period of time required by a processor in a CEW to initiate a pulse and terminate the pulse. The minimum pulse duration may be equal or greater than a minimum period of time required by a processor in a CEW to initiate a pulse, measure a current of the pulse, select a pulse duration, and terminate the pulse in accordance with the pulse duration. In some embodiments, a minimum pulse duration may be determined in accordance with a maximum measured current that may be applied to a load impedance by a conducted electrical weapon and a predetermined minimum charge to be delivered to the target in accordance with the maximum current. In embodiments, a minimum pulse duration may comprise a pulse duration value equal or greater than 20 μS, equal or greater than 35 μS, or less than 50 μS.

In embodiments, range 420 may be greater than a maximum pulse duration. For example, each duration within range 420 may be equal or less than fifth pulse duration 420-5. The maximum pulse duration may be determined in accordance with a minimum measured current that may be applied to a load impedance coupled a conducted electrical weapon and/or a maximum charge value to be applied to a load impedance via a single pulse of a stimulus signal. In embodiments, a maximum pulse duration may comprise pulse duration value equal or less than 200 μS, equal or less than 175 μS, or at least 150 μS. In embodiments, range 420 may comprise a pulse duration values between a minimum pulse duration and a maximum pulse duration. Each pulse delivered by a conducted electrical weapon may comprise a pulse duration within range 420.

In embodiments, selecting a pulse duration in accordance with a measured current may comprise selecting a pulse duration from range 420 in accordance with a measured current in range 410. The selecting may select a different pulse duration from range 420 for each different measured current from range 410. For example, first pulse duration 420-1 may be selected in accordance with first measured current 410-1, second pulse duration 420-2 may be selected in accordance with second measured current 410-2, third pulse duration 420-3 may be selected in accordance with third measured current 410-3, fourth pulse duration 420-4 may be selected in accordance with fourth measured current 410-4, and/or fifth pulse duration 420-5 may be selected in accordance with fifth measured current 410-5.

In embodiments, a pulse duration may provide a charge in accordance with the measured current for which the pulse duration may be selected. A pulse delivered in accordance with each measured current of range 410 may deliver a charge associated with a pulse duration selected for the measured current among range 420. Each pulse duration may have an associated charge. For example, a first charge may be delivered in accordance with first measured current 410-1 and first pulse duration 420-1, a second charge may be delivered in accordance with second measured current 410-2 and second pulse duration 420-2, a third charge may be delivered in accordance with third measured current 410-3 and third pulse duration 420-3, a fourth charge may be delivered in accordance with fourth measured current 410-4 and fourth pulse duration 420-4, and a fifth charge may be delivered in accordance with fifth measured current 410-5 and fifth pulse duration 420-5. An example set of charges (i.e., charge values) associated different combinations of measured currents and pulse durations is indicated by the left vertical axis in FIG. 4.

In embodiments, the current delivered to a target via a pulse may not be controllable by a conducted electrical weapon. Rather, the current, and thus measured current, may be determined by a load impedance to which the stimulus signal from the conducted electrical weapon is delivered. A processor, signal generator, or other components of the conducted electrical weapon may not, for example, adjust a voltage or a current of the stimulus signal applied to the same load impedance based on a value of the load. The processor, signal generator, or other components of the conducted electrical weapon may not, for example, adjust a voltage or a current of the stimulus signal while the stimulus signal is applied to the same load impedance. However, the conducted electrical weapon may select a pulse duration by which a pulse may be delivered. Accordingly, and in various aspects of the present disclosure, different and/or same charges may be applied in accordance with different pulse durations selected by the conducted electrical weapon. The conducted electrical weapon may control a charge applied by a pulse in accordance with the pulse duration selected by the conducted electrical weapon over which the pulse is applied to a load impedance.

In embodiments, range 420 may comprise different pulse durations associated with different charges. For example, a first pulse applied in accordance with a first measured current and a first selected pulse duration may deliver a first charge that is different from a second charge delivered in accordance with a second measured current different from the first measured current and a second duration different from the first duration. For example, a first charge delivered in accordance with first measured current 410-1 and first pulse duration 420-1 may be different from a second charge delivered in accordance with second measured current 410-2 and second pulse duration 420-2. In embodiments, a range of charges associated with range of pulse durations may be between 50 microcoulombs (μC) and 85 μC. In embodiments, the charge values illustrated in left vertical axis of FIG. 4 may increase for each unit from C1 to C12, wherein C12 has a greater charge value than C1. The charge values along the axis may start at 50 μC and increment 5 μC per unit. For example, C1 may equal 50 μC and C12 may equal 105 μC. Each marked increment C2-C11 may increase sequentially by 5 μC from C1 (C2=55 μS, C3=30 μC, etc.) In other embodiments, pulse durations may be determined to be associated with different charge values and ranges of charges according to various aspects of the present disclosure.

In embodiments, a charge applied in accordance with different pulse durations may be selected to increase as measured currents associated with each pulse duration of the different pulse durations decrease. For example, a first charge delivered by a first pulse in accordance with a first measured current and a first pulse duration may be less than a second charge delivered by a second pulse in accordance with a second measured current less than the first measured current and a second duration different from the first duration. An increase in the second pulse duration relative to the first pulse duration may cause the second charge delivered by the second pulse to be greater than the first pulse, despite the decrease between the first measured current and the second measured current. For example, a third charge delivered in accordance with third measured current 410-3 and third pulse duration 420-3 may be greater than a second charge delivered in accordance with second measured current 410-2 and second pulse duration 420-2, wherein third measured current 410-3 is less than second measured current 420-2. The relative rate of increase between the first and second pulse durations may be disproportionate relative to the relative rate of decrease between the first and second measured currents.

In embodiments, range 420 may comprise different pulse durations associated with a same charge. For example, a linear inverse relationship may be provided between measured currents and pulse durations selectable for the measured currents. An increase in current between a first measured current and a second current may cause a corresponding decrease between a first pulse duration associated with the first measured current and a second pulse duration associated with the second measured current. A first pulse applied in accordance with the first measured current and the first selected pulse duration may deliver a same charge as a second pulse delivered in accordance with the second measured current and the second duration. In embodiments, a subset of range of pulse durations 420 may be associated with a same or constant charge. In some embodiments, the subset of range of pulse durations 420 associated with the constant charge may be associated with a subset of minimum measured currents of a range of measured currents 410. The subset of range of pulse durations 420 associated with the constant charge may comprise, for example, first measured current 410-1. The subset of range of pulse durations 420 associated with the constant charge may comprise, for example, a range of measured currents between first measured current 410-1 and second measured current 410-2. The subset of range of pulse durations 420 associated with the constant charge may comprise pulse durations in the shorter half of durations of range 420. In some embodiments, the charge may comprise a maximum charge delivered by a pulse of a stimulus signal. For example, a subset of range 420 between fourth pulse duration 420-4 and fifth pulse duration 420-5 may be determined (selected, matched, calculated, etc.) to provide a maximum charge. A fourth charge delivered in accordance with fourth measured current 410-4 and fourth pulse duration 420-4 may be equal to a fifth charge delivered in accordance with fifth measured current 410-5 and fifth pulse duration 420-5, even though fifth measured current 410-5 is less than fourth measured current 410-4.

In embodiments, a range of pulse durations 420 may comprise subsets of pulse durations that are associated with different charges and same charges. A first subset of range 420 may be associated with a first subset of different charges, while a second subset of range 420 may be associated with a same charge. For example, a subset of pulse durations between first pulse duration 420-1 and fourth pulse duration 420-4 may each be associated with a different associated charge, while a subset of pulse durations between fourth pulse duration 420-4 and fifth pulse duration 420-5 may each be associated with a same charge. Such same and different charges may enable a corresponding pulse to be provided in a safe and effective manner for each measured current of a range of measured currents 410.

In embodiments, the charges associated with a pulse duration may be calculated charges. For example, the values indicated along the left vertical axis may comprise calculated charge values. The charges may indicate a charge that is calculated to be delivered to a same load impedance based on a measured current and a selected duration. In some embodiments, the calculated charges may differ from charges that are actually delivered to a target. For example, a change in load impedance between electrodes may result in a change of current relative to a measured current. In turn, this change of current may cause the actual charge delivered relative to a selected duration and previously measured current. In embodiments, a calculated charge may be associated with a selected duration independent of an actual charge delivered to a target based on the selected duration. The calculated charge may indicate a predetermined charge. A plurality of predetermined, calculated charges may be associated with a corresponding plurality of predetermined durations independent of whether a change in impedance through which the stimulus signal is delivered occurs or does not occur after the duration is set. In embodiments, other circuits and/or manners of control may be implemented to ensure that an amount of charge applied via a stimulus signal does not exceed a predetermined maximum value for safety, power management, or other considerations.

The foregoing description discusses implementations (e.g., embodiments), which may be changed or modified without departing from the scope of the present disclosure. Examples listed in parentheses may be used in the alternative or in any practical combination. As used in the specification and illustrative embodiments, the words ‘comprising,’ ‘comprises,’ ‘including,’ ‘includes,’ ‘having,° and ‘has’ introduce an open-ended statement of component structures and/or functions. In the specification and illustrative embodiments, the words ‘a’ and ‘an’ are used as indefinite articles meaning ‘one or more’. In the illustrative embodiments, the term “provided” is used to definitively identify an object that not a claimed or required element but an object that performs the function of a workpiece. For example, in the illustrative embodiment “an apparatus for aiming a provided barrel, the apparatus comprising: a housing, the barrel positioned in the housing”, the barrel is not a claimed or required element of the apparatus, but an object that cooperates with the “housing” of the “apparatus” by being positioned in the “housing.”

The location indicators “herein,” “hereunder,” “above,” “below,” or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. As used herein, numerical terms such as “first”, “second”, and “third” may refer to a given set of one or more elements, independent of any order associated with such set. For example, a “first” electrode may include a given electrode that may be deployed before or after a “second” electrode, absent further recited limitations of order.

1. A method performed by a conducted electrical weapon to generate a stimulus signal, the method comprising:
measuring a current delivered by the stimulus signal to provide a measured current; and
setting a duration of the stimulus signal in accordance with the measured current.

2. The method of claim 1, wherein measuring the current comprises measuring a current of a pulse of the stimulus signal.

3. The method of claim 1, wherein measuring the current comprises measuring a peak current of the stimulus signal.

4. The method of claim 1, wherein measuring the current comprises measuring the stimulus signal while the stimulus signal is delivered.

5. The method of claim 1, wherein measuring the current comprises measuring the stimulus signal within a period after delivery of the stimulus signal is initiated.

6. The method of claim 5, wherein the period comprises less than twenty microseconds.

7. The method of claim 1, further comprising delivering the stimulus signal to a target at a constant current.

8. The method of claim 1, comprising measuring a second current delivered by a second stimulus signal to provide a second measured current; and
setting a second duration of the second stimulus signal in accordance with the second measured current, wherein the second duration of the second stimulus signal is different from the duration of the stimulus signal.

9. The method of claim 8, wherein the second duration of the second stimulus signal is greater than the duration of the stimulus signal; and
the second measured current is less than the measured current.

10. The method of claim 8, wherein a first charge delivered in accordance with the measured current and duration is different from a second charge delivered in accordance with the second measured current and the second duration.

11. The method of claim 10, wherein the second charge is greater than the first charge and the measured current is greater than the second measured current.

12. The method of claim 1, wherein selecting the duration comprises matching the measured current with a corresponding duration using a table that correlates measured currents to corresponding pulse durations, wherein the duration comprises the corresponding duration and the table is stored in a processor of a conducted electrical weapon or accessed from a non-transitory, computer-readable memory of the conducted electrical weapon by the processor.

13. A conducted electrical weapon configured to conduct an electrical stimulus signal through a target, the conducted electrical weapon comprising:
a signal generator configured to generate the stimulus signal;
a plurality of electrodes electrically coupled to the signal generator to receive the stimulus signal;
a pulse sensor coupled to the signal generator; and
a processing circuit communicatively coupled to the plurality of electrodes, signal generator, and the pulse sensor, wherein the processing circuit is further configured to perform operations, comprising:
measuring, via the pulse sensor, a current of a pulse of the stimulus signal delivered to the target via the plurality of electrodes; and
setting, via the signal generator, a duration of the pulse of the stimulus signal in accordance with the measured current.

14. The conducted electrical weapon of claim 13, wherein the pulse sensor comprises a peak current sensor and the current of the stimulus signal comprises a peak current of the stimulus signal.

15. The conducted electrical weapon of claim 13, wherein:
the signal generator is configured to generate the stimulus signal at a constant current; and
the operations comprise initiating delivery of the pulse of the stimulus signal, wherein initiating the delivery of the pulse comprises providing the pulse of the stimulus signal to the target at the constant current.

16. The conducted electrical weapon of claim 13, wherein setting the duration comprises selecting the duration from a range of pulse durations for which the pulse of the stimulus signal may be applied by the conducted electrical weapon, and wherein the range of pulse durations comprises a range of increasing pulse durations associated with a range of increasing charges.

17. The conducted electrical weapon of claim 16, wherein the range of increasing pulse durations comprises:
a first pulse duration associated with a first charge and a first measured current in a range of measured currents; and
a second pulse duration associated with a second charge and a second measured current in the range of measured currents, wherein the second charge is greater than the first charge and the first measured current is greater than the second measured current.

18. The conducted electrical weapon of claim 16, wherein the range of pulse durations comprises a second range of increasing pulse durations associated with a range of constant charges.

19. The conducted electrical weapon of claim 13, wherein the current of the pulse of stimulus signal is determined in accordance with a load impedance of the target to which the pulse of the stimulus signal is delivered.

20. The conducted electrical weapon of claim 13, wherein measuring the current of the pulse comprises measuring the current of the pulse of the stimulus signal within a period of less than twenty microseconds after delivery of the pulse of the stimulus signal is initiated.
